(19) United States
(12) Patent Application Publication
(10) Pub. No.: US 2017/0032004 A1
(43) Pub. Date: Feb. 2, 2017

(54) CORE DATA SERVICES BASED CROSS-SYSTEM ANALYTICS

(71) Applicant: SAP SE, Walldorf (DE)

(72) Inventor: Siar Sarferaz, Heidelberg (DE)

(21) Appl. No.: 14/812,810

(22) Filed: Jul. 29, 2015

(51) Int. Cl. G06F 17/30

(52) U.S. Cl. CPC G06F 17/30575; G06F 17/30292

(57) ABSTRACT

The present disclosure relates to methods and systems for replicating data from one or more sources to a database and creating a virtual data model of the replicated data. Data from each source may be replicated into its own data base schema. The data may be harmonized before replication to the data base. One or more views for each schema may be created and a cross view may subsequently be defined based on the views created for each schema, resulting in a virtual data model. The virtual data model may be used to perform data analytics.

### BACKGROUND

The present disclosure relates to data analytics. In particular, data analytics using virtual data models.

A purpose of cross-system analytics is to consolidate, transform and clean data from different data sources and thereby provide a central and consistent view for reporting and analyzing data within an organization. To provide a holistic overview of the company's situation, data originating from various source systems may be harmonized and combined throughout the whole company.

When data is exchanged among several source systems, there is a high probability that data may not fit together from a business or technical context. For example, master data, such as cost centers involve identical cost center keys that may exist in multiple source systems with different cost centers assigned. When the data is exchanged, functionality is needed to bring the different data sets together to create one common data foundation. Besides transformation data consistency must be ensured. For example, different releases of source systems must be managed, replication dependencies (e.g. master-detail) have to be considered and separation of data from different source systems must to be supported. In addition, it's also necessary to monitor the logic and the flow of data exchanged from various systems.

Present solutions involve defining the core data model numerous times for different purposes. In addition, most cases involve the addition of only minor metadata. For example technology solutions for integration, user interface, analytics or transactions may require their own data models. This increases the total cost of ownership (TCO) as the same content must be provided several times. Due to the incompatible meta-models, cross topics such as UI integration, extensibility or authorization, must be solved various times. This results in high TCO and results in consumption of resources by customers.

Therefore, the inventors perceive a need for a single core data model that can be defined and reused in different contexts by domain-specific enhancements.

### BRIEF DESCRIPTION OF DRAWINGS

FIG. 1 illustrates a system architecture diagram of a system according to an embodiment of the present disclosure.

FIG. 2A illustrates a system architecture diagram of a system according to another embodiment of the present disclosure.

FIG. 2B illustrates a system architecture diagram of a system according to another embodiment of the present disclosure.

FIG. 3 illustrates a system architecture diagram according to another embodiment of the present disclosure.

FIG. 4 illustrates a system architecture diagram according to an embodiment of the present disclosure.

FIG. 5 illustrates a diagram of multiple system deployments according to an embodiment of the present invention.

FIG. 6 illustrates a flow diagram of a method according to an embodiment of the present invention.

### DETAILED DESCRIPTION

In an embodiment, methods and systems are described for performing cross system data analytics using a data base system that can provide a core data model which may be defined and reused in different contexts by domain-specific enhancements. Thus redundant data modeling is avoided and cross topics are solved uniformly resulting in a simple and powerful solution architecture.

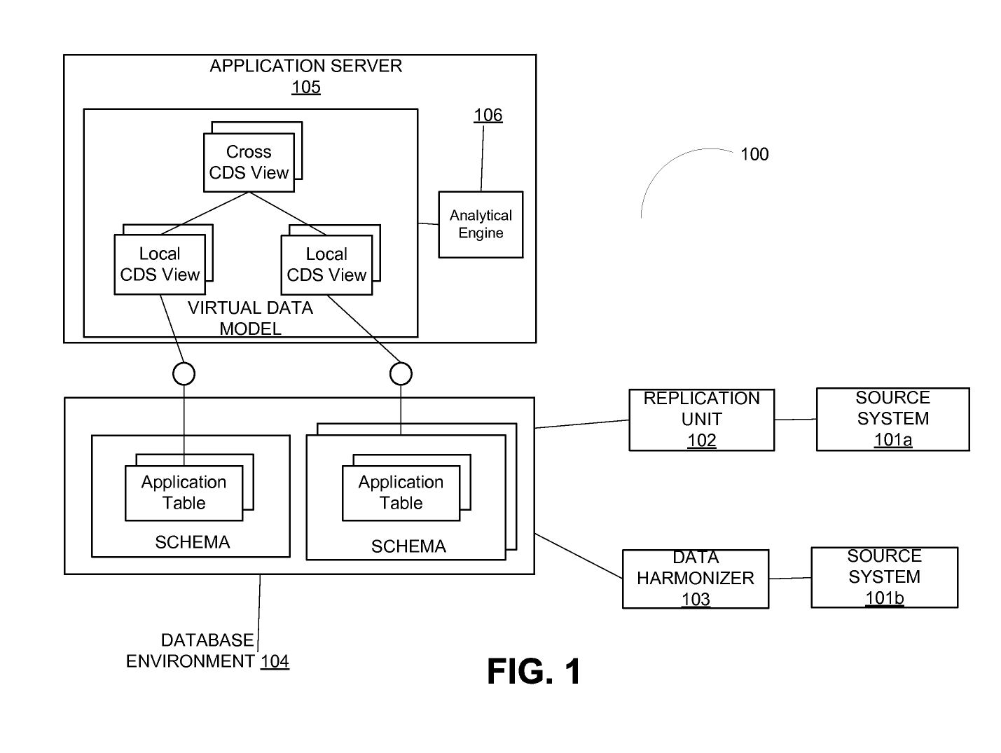

FIG. 1 illustrates a system architecture diagram of the system 100 according to an embodiment of the present invention. System 100 may include one or more source systems 101a . . . n, replication unit 102, database environment 104 and application server 105. System 100 may be deployed in a variety of environments, such as within a cloud system, on a user premises, or in a privately managed cloud. In an embodiment, system 100 may represent operation of a database system/application server instance that is in use (for example, by a client).

Source system 101 may include a database having one or more application database tables (not shown). Source system 101 may detect changes or modifications to the database tables. Source system 101 may use data base triggers to detect changes or modifications to the database tables. In an embodiment, source system 101 may respond to a table being selected for replication by automatically creating data base triggers and related change logs to track and log changes for each table within source system 101. Database triggers may be processes that are stored in a database of source system 101 and are executed in response to a triggering event, such as when a table associated with the database is modified. For example, a database trigger may allow source system 101 to detect the execution of SQL statements such as “insert”, “delete” or “update” on a table. In response, a read module (not shown) of source system 101 can read the modified data from the application database tables and transfer the modified data to replication unit 102. In an embodiment, replication unit 102 may contain a read module which can read and transfer the modified data to itself from the source system 101 in response to a database trigger.

Upon receiving modified data, replication unit 102 may replicate the modified data to the target system. Replication unit 102 may replicate data from one or more source systems to the database environment 104. Replication unit 102 may perform an initial load of data from a source system 101 to a database environment prior to replicating changes or modifications to the data from the source system 101 to the database environment 104. Subsequently, replication unit 102 may utilize a read module (not shown) to retrieve data from application tables of the source systems in response to an indication that a change in the relevant tables of the source system has occurred (such as a database trigger). In an embodiment, replication unit 102 may utilize configuration parameters to load and replicate data from the source system. Configuration parameters may contain information about the source system, the database environment and the relevant connections between the two. Configuration parameters may be specified by a user.

Based on the configuration parameters, replication unit 102 may load and replicate data from one or more source systems to a database environment (1:1 or N:1 replication) or load and replicate data from one source system to up to four database environments (1:N replication). In an embodiment, replication unit 102 can replicate data from each different source system into a respective database environment schema.

Replication unit 102 may utilize delta logging when replicating data. Using delta logging may enable replication unit 102 to replicate only the modifications to a table, instead of replicating the entire table again to the database environment. In this way, replication unit 102 can greatly reduce data redundancy. Replication unit 102 may be any suitable infrastructure component, such as a replication server for example.

In an embodiment, replication unit 102 may replicate data in real time, or may schedule the replication by time interval.

In an embodiment, system 100 may include a preprocessing unit 103. Preprocessing unit 103 may harmonize data when heterogeneous data is present between the source system and database environment. Heterogeneous data may include data that is structural and not semantically consistent. Preprocessing unit may perform staging, duplicate elimination and/or key mapping in order to harmonize the data prior to replication.

Replication unit 102 can transfer the data to be replicated into application data base tables within the one or more respective schemas of database environment 104. The application database tables may represent a persistency layer of the database environment 104. Database environment 104 can access data locally and dynamically once it has been replicated from the source system.

In an embodiment, system 100 may utilize process integration techniques to access data from source systems remotely. Process integration interfaces may have static signatures and may be designed for remote calls. Remote calls are slower than local calls (used in replication) by a factor of 1000 and involve high cost. Therefore, remote access may be utilized for low data volume operations but may have limited applicability elsewhere.

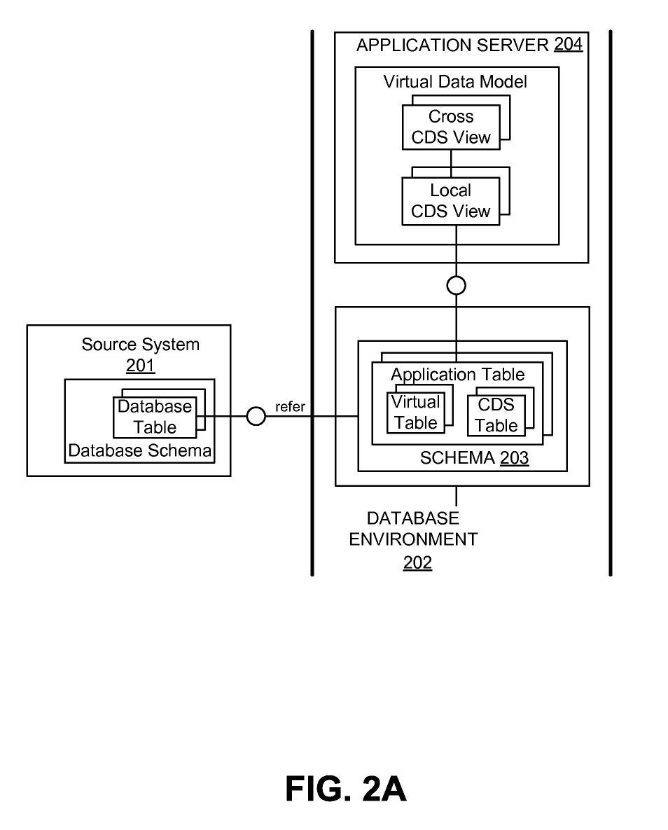

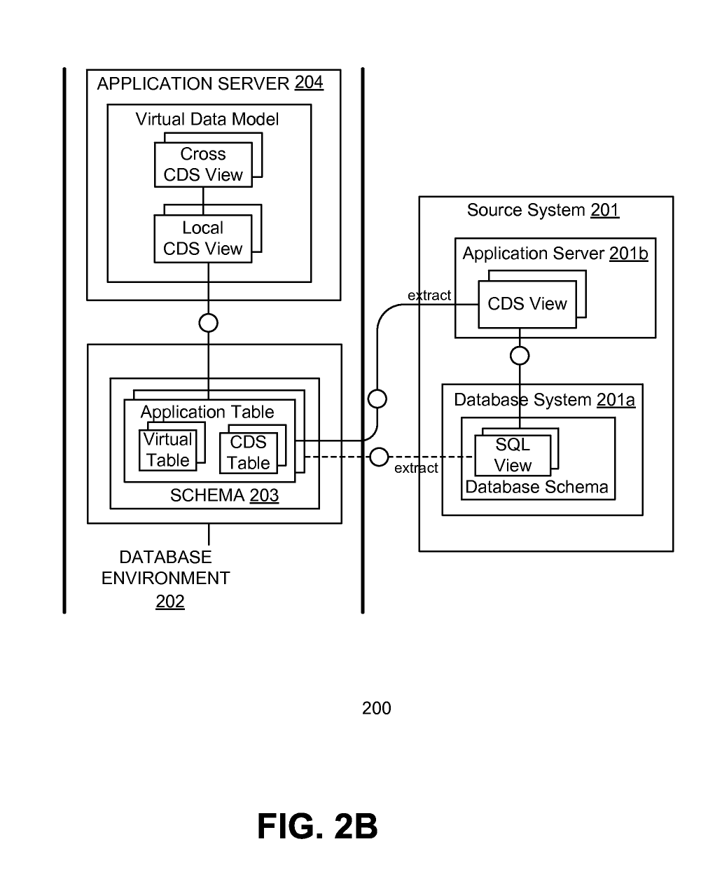

In an embodiment, system 100 may utilize a remote data access method such as smart data access to transfer data. FIG. 2A illustrates a system architecture diagram of a system 200 that may utilize smart data access to replicate data according to an embodiment of the present disclosure. Database environment 202 may include one or more virtual tables within each schema 203. Each virtual table may refer to a database table within a source system 201 remotely. The virtual table may then be used as the basis for generation of local views, cross views and analytic functionality by an application server 204 as described herein.

In an embodiment, system 100 may utilize an extraction technique such as CDS extraction to replicate data from a source system. FIG. 2B illustrates a system architecture diagram of a system that may utilize extraction to replicate data according to an embodiment of the present disclosure. Source system 201 may include a database environment 201a and application server instance 201b. Application server 201b may generate local views of the data within database system 201a. Application server 201b may mark certain views for replication using an extraction indicator to mark certain views. Database environment 202 may remotely select all views having the extraction indicator and persist the results locally. Database environment 202 may cache the views and application server 204 may generate local views on top of the views being persisted within database environment 202. Application server 204 may use the local views based on the persisted views to generate cross views, and enable analytic functionality.

Returning to FIG. 1, database environment 104 may include databases to store replicated information. Database environment 104 may be any suitable data storage mechanism. By way of non-limiting example, database environment 104 may be an SAP HANA database. Each database may include one or more schemas for each source system. Each schema may include one or more application database tables. The application database tables may represent a persistency layer of database environment 104. Database environment 104 can access data locally and dynamically once it has been replicated from the source system. Database environment 104 and replication unit 102 may communicate with each other via a database connection. In an embodiment, replication unit 102 may replicate data from each external source system to a respective schema of database environment 104.

Subsequently, application server 105 may define a set of views for each schema respectively. Each view may be based on one or more application tables from the respective schema. Application server 105 may then define a cross view integrating views for one or more schemas to create a virtual data model (VDM).

Application server 105 may contain analytical engine 106. Analytical engine 106 may consume the views that make up the VDM and perform analytical functions using the VDM. Analytical engine 106 may consume the views and evaluate the metadata of the views, especially the analytical annotations, to enable analytic functionality. Metadata may include behavioral components of the data, the manner in which data is aggregated and how data is displayed in the user interface among other aspects. Specific analytic functionality may be in the form of application logic. Analytical engine 106 may receive application logic in the form of SQL script, or any other declarative and optimizable language for expressing application logic. Application logic may represent user defined functionality such as cross view defining, statistical analysis and hierarchy handling. Analytical engine 106 can compile the application logic into a calculation model, which can be accessed in the same manner as a database model. Therefore, the calculation model may be a kind of parameterized view capable of reuse. Examples of analytical functions that analytic engine 106 may undertake include statistical algorithms, planning and other special operators.

In an embodiment, the database environment 104 and application server 105 may act as an “empty” central hub, in order to facilitate large volumes of data from large numbers of source systems. Many instances of a database environment 104 and application server 105 may already have a large amount of throughput from many source systems. For example, a client system may have a large number of users and a large amount of data within the database environment, as well as a large number of applications running on the application server. Because of this, systems in use such as the client system in the example above cannot handle a large number of external systems. By providing an empty instance of a database environment and application server to act in the role of a central hub, analytic engine 106 may perform analytics for a large number of source systems and high data volume.

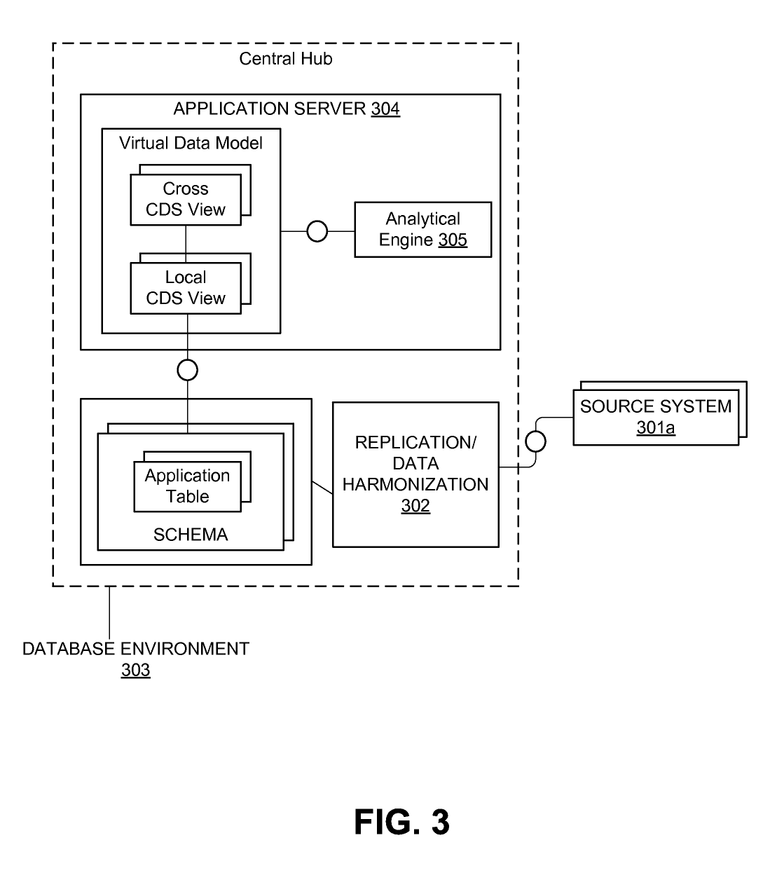

FIG. 3 illustrates a system 300 in accordance with an embodiment of the present disclosure. In particular, FIG. 3 illustrates the system 300 in a central hub configuration. System 300 may include one or more source systems 301a . . . n, replication/data harmonization unit 302, database environment 303, application server 304 and analytical engine 305. System 300 may be the basis for cross-system analytics in scenarios involving a large number of source systems and high data volume. System 300 may replicate data as discussed herein. System 300 may also define views and cross views as well as perform data analytics as discussed herein. System 300 may re-use views as well as data models and previous calculations (the previous calculations may form a type of parameterized view which can be reused as discussed further herein).

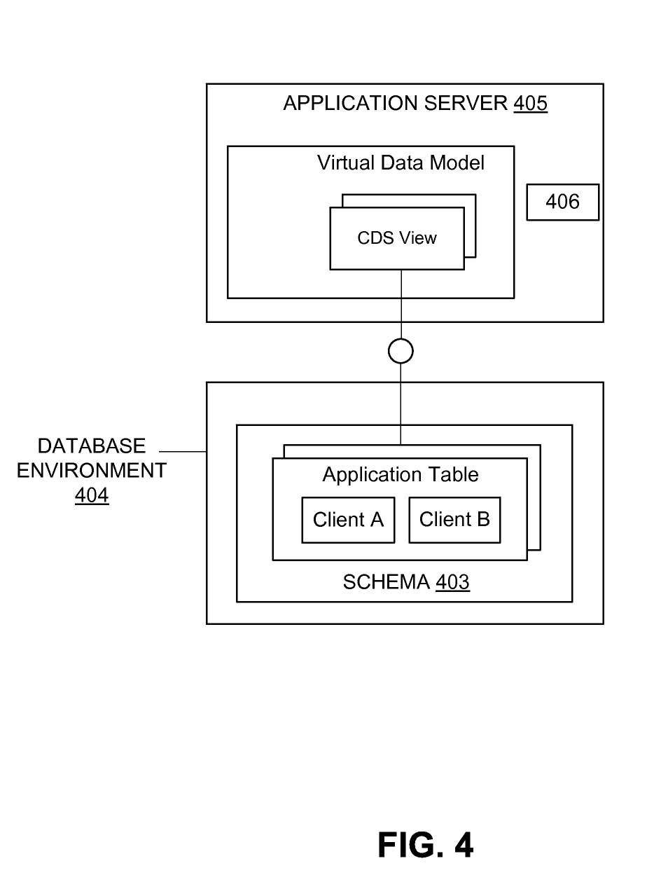

FIG. 4 illustrates a system 400 in a cross client configuration. In an embodiment, system 400 may consolidate data originating from different clients within a single database schema 403. Data within an application table of a database schema may be divided by client. The data may have a client-element attribute associated with it. Therefore, application server 405 may define views having a client-element attribute, making each view client dependent (i.e. they are associated with a particular client). When combining views into a VDM, analytic engine 406 may implicitly enrich SQL statements by adding the required metadata to filter data via the client-element attribute. In this way, system 400 may determine the semantic applicability of data from each client based on the client-element attribute.

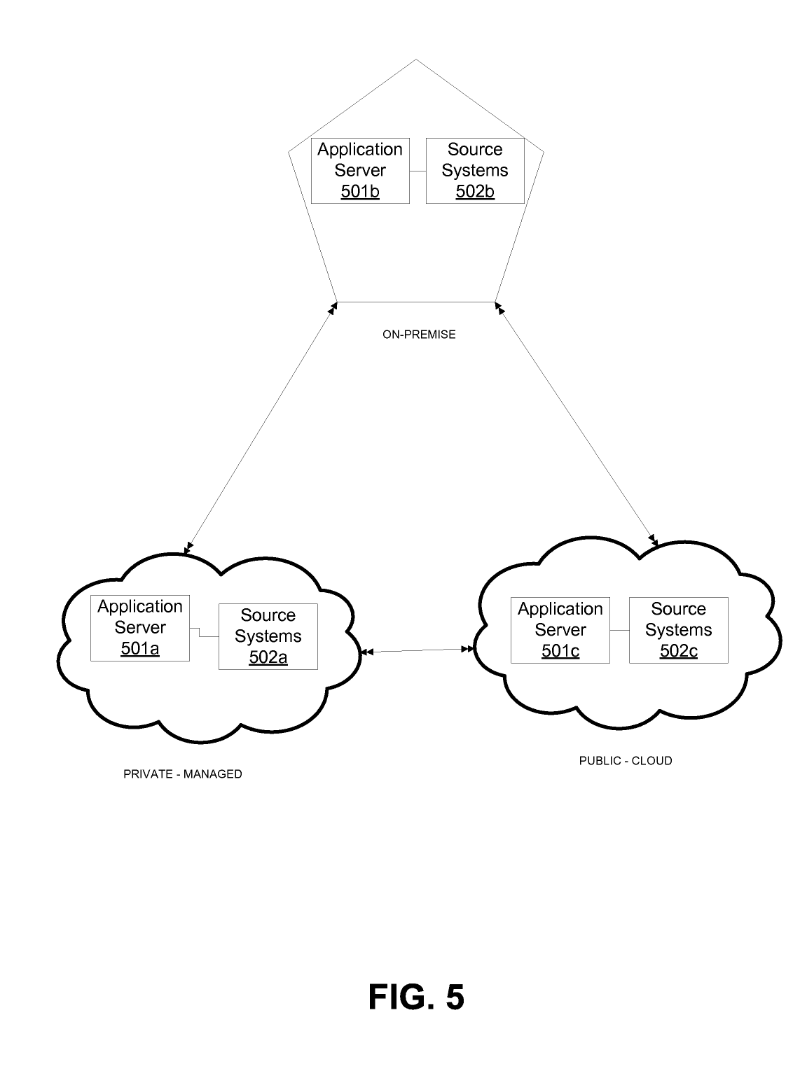

FIG. 5 illustrates multiple deployment clusters for a system according to an embodiment of the present disclosure.

In an embodiment, when transferring between systems in the same deployment cluster (i.e. between 501a and 502a, or 501c and 502c), or between privately managed and public cloud systems, such systems may perform data replication as described herein.

However, in cross system scenarios involving the transfer of data between on premise and privately managed or public cloud systems, such systems may use remote communication to replicate data. Due to the lack of physical proximity, such systems may replicate initial data and deltas using remote communication when the data volume involved is below a certain threshold. Remote communication may be any conventional technique for wirelessly transmitting data. For example, such systems may use process integration techniques to transfer certain data that is less distributed, such as aggregates.

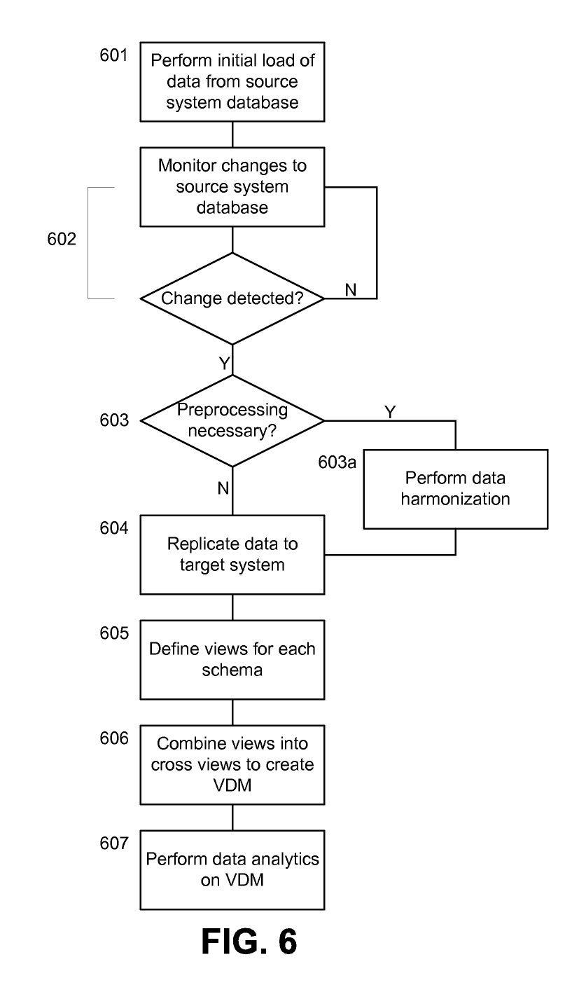

FIG. 6 illustrates a flow diagram of method 600 according to an embodiment of the present disclosure.

At step 601, method 600 may perform an initial load of data from a source system to a target system prior to replicating data from the source system to the target system. Method 600 may retrieve data from application tables of the source system. In an embodiment, method 600 may utilize configuration parameters to load and replicate data from the source system. Configuration parameters may contain information about the source system, the target system and the relevant connections and can be specified by a user. Before the initial load procedure commences, method 600 can create database trigger and related logging tables for each table in the source system that is selected for replication by method 600 as well as additional replication-related objects in a replication unit.

Method 600 may load and replicate data from one or more source systems to one target system (1:1 or N:1 replication). In addition, method 600 can load and replicate data from one source system to up to four target systems (1:N replication). In an embodiment, method 600 can replicate data from each different source system into a respective target system schema.

In an embodiment, method 600 may load and replicate the data in real time, or may schedule the replication by time interval.

In an embodiment, method 600 can utilize preprocessing features to harmonize data that is structural and not semantically consistent before it is replicated. Examples of the preprocessing features include staging, duplicate elimination and key mapping.

At step 602 method 600 can initialize data replication upon detecting a change or modification within a source database and replicate data to the target system accordingly. Method 600 may track changes or modifications to the application database tables of one or more source systems. Method 600 may utilize database triggers to monitor changes. Database triggers may be processes that are stored in the database and are executed in response to a triggering event, such as when a table associated with the database is modified. For example, method 600 may replicate data in reaction to SQL statements such as an “insert”, “delete” or “update” statement operating on a table and in response, may read the modified data from the application database tables and transfer the modified data to a target system. Method 600 may record information about modifications to databases within the logging tables.

If no change is detected, then method 600 may continue monitoring the source databases for changes. Upon detecting a change, method 600 may proceed to step 603.

At step 603, method 600 may determine if preprocessing is necessary. Method 600 may utilize preprocessing to harmonize heterogeneous data between the source and target systems. Heterogeneous data may include data that is structural and not semantically consistent. Method 600 can perform staging, duplicate elimination and/or key mapping among other processes in order to harmonize the data prior to replication.

At step 604, method 600 may replicate the data bases where a change or modification was detected as described above. This manner of replication may be known as transactional replication. In an embodiment, method 600 may utilize delta logging when replicating data. Using delta logging, method 600 may replicate only the modifications to a table, instead of replicating the entire table again to the target system which may greatly reduce data redundancy.

In an embodiment, method 600 may utilize custom transformation rules to transfer only desired application tables or transfer only certain data from one or more application tables. Method 600 may use the transformation rules to filter data from application tables based on user defined filters. Custom transformation rules may also enable other transformations of the data during replication. For example, certain transformation rules may provide for data filtering, enrichment of table structure, anonymizing data converting fields, filling empty fields or skipping records in application tables.

Method 600 can transfer the data to be replicated from each source system into a respective schema of the target system. Specifically, method 600 may replicate data to application data base tables within the one or more respective schemas of the target system. The application database tables may represent a persistency layer of the target system. The target system can access data locally and dynamically once it has been replicated from the source system.

In an embodiment, method 600 can use snapshot replication. Using snapshot replication, method 600 may transfer data for a specific time and date point from a source system to a target system.

In an embodiment, method 600 can use merging replication. Using merging replication, method 600 may combine data from two or more systems into a single system.

In an embodiment, method 600 may utilize an extract, transform and load process to transfer data from a source system to a target system.

In an embodiment, method 600 can access data from a source system by using local virtual tables. Local virtual tables can refer to external tables (i.e. from a source system).

At step 605, method 600 can define a set of views for each schema respectively. Each view may be based on one or more application tables from the respective schema.

Method 600 may use the infrastructure of a database environment to define views. A database environment may include a common set of domain-specific languages (DSL) and services for defining and consuming semantically rich data models. The set of DSLs may serve as a common core model.

In an embodiment, method 600 can use table functions to access source system schemas. This may be useful in situations involving for example, cross-system analytics. Table functions are data dictionary objects that are defined via data dictionary language sources, however they are not database independent. Table functions represent native SQL functions. Method 600 may create a set of views for one schema, and use table functions to define a set of views for any further schemas.

At step 606 method 600 may combine the views into a cross view to define the virtual data model (VDM). Method 600 may use an SQL function such as “union” to define a cross view integrating views for all schemas. By crossing views, method 600 can provide a reusable, semantic layer which can be consumed in different scenarios. For example, the crossed views can be used for analytics, planning, search or transactional processes.

At step 607, method 600 may consume the views that make up the VDM and perform analytical functions using the VDM. Method 600 may use an analytical engine to perform analytical functions. Method 600 may consume views and evaluate the metadata of the views, especially the analytical annotations, to enable analytic functionality. Metadata may include behavioral components of the data, the manner in which the data is aggregated and how the data is displayed in the user interface among other aspects. Analytic functionality may be represented by application logic. Method 600 may receive application logic in the form of SQL script, or any other declarative and optimizable language for expressing application logic. Application logic may represent user defined functionality such as cross view defining, statistical analysis and hierarchy handling. Method 600 may compile the application logic into a calculation model, which may be accessed in the same manner as a database model. Therefore, the calculation model may be a kind of parameterized view capable of reuse. Examples of analytical functions that method 600 may undertake include statistical algorithms, planning operations and other special operations.

Because method 600 may use a single consistent programming model, parameters such as integration are already solved for views. Thus, method 600 may perform the analytical functions as discussed herein using the same analytics programming model used in previous views. Method 600 may treat views as the development artifact and may reuse already existing content such as calculation models or data. Because method 600 does not need to change the programming model, it does not need to remodel all content being defined with views.

In an embodiment, method 600 may facilitate large volumes of data from large numbers of source systems by replicating data to and performing analytics with an “empty” instance of a target system. A target system may include a database environment and an application server among other components. Many instances of a target system may already have a large amount of throughput. For example, a client system consisting of a database environment and an application server may have a large number of users and a large amount of data within the database environment, and a large number of applications running on the application server. Because of this, systems in use such as the client system in the example above cannot handle a large number of external systems. By replicating to and performing analytics with an empty instance of a target system acting in the role of a central hub, method 600 may perform analytics for a large number of source systems and high data volume.

In an embodiment, method 600 may consolidate data originating from different clients within a single database schema. Data within an application table of a database schema may be divided by client. Therefore, method 600 may define views with a client-element attribute, making each view client dependent (i.e. they are associated with a particular client). When combining views into a VDM, method 600 may implicitly enrich SQL statements by adding the required metadata to filter data via the client-element attribute. In this way, method 600 may determine the semantic applicability of data from each client based on the client-element attribute.

In an embodiment, method 600 may include client handling functionality. In some cases, source systems may contain data from several clients. Thus, when replicating, data pertaining to all clients may be stored in the same schema. This may result in the view for that schema containing data for multiple clients. Upon creating views for the data in a database environment, method 600 may determine which data relates to which client based on the client-element attribute associated with the data. However, although data for each respective client has a client identifier attribute, it may be difficult to determine which client data is relevant when defining cross views. In an embodiment, method 600 solves this problem by using cross views to expose the logical system for the involved systems. The logical system may represent the client and the source system instance as a concatenated identifier. Logical systems may be stored in a separate logical system table. Upon creating cross views, method 600 may enrich the cross views with the logical system for each source system by using an appropriate SQL operation such as “join” to combine the logical system table into the cross views resulting in views having a logical system attribute.

In an embodiment, customers may define authorizations based on the logical system attribute. In an embodiment, customers may define these authorizations within the application logic representing analytic functionality. Such authorizations may include a system type and a client id. Based on the authorizations, Method 600 may then restrict crossed views to the relevant clients of the involved systems based on the user defined parameters of the logical system attribute.

In an embodiment, method 600 may use the logical system attribute to differentiate records. Situations involving multiple instances of the same type of source system may result in different records having the same identification key. Therefore, reporting on cross views that union the records of the involved systems can result in incorrect values (e.g. aggregation of values with identification key of 1000). Method 600 may enrich the cross views with the logical system attribute for each source system (described herein) by using an appropriate SQL operation such as “join” to combine the logical system table into the cross views resulting in views having a logical system attribute.

In an embodiment, method 600 may manage the transfer of data between various deployments. A public managed cloud may be managed by an entity. A privately managed cloud may be hosted by an entity and managed by customers (implementations, extensibility handled by customer). Data replication between a database environment and source systems within the same deployment cluster are uncritical, since the systems are physically close to each other. This is also true for data replication between privately managed and public cloud deployments because these clusters could be hosted by a single entity and therefore be located physically close to each other. Techniques such as data compression may be used to facilitate data replication in these scenarios.

In an embodiment, method 600 may use remote communication to replicate data in a cross system scenario involving the transfer of data between different deployment clusters. For example, method 600 may use remote communication for data transfers between on premise and privately managed or public cloud deployment clusters. Due to the lack of physical proximity, method 600 may replicate initial data and deltas using remote communication when the data volume involved is below a certain threshold. Remote communication may be any conventional technique for wirelessly transmitting data. For example, method 600 may use process integration techniques to transfer certain data that is less distributed, such as aggregates.

In an embodiment, when transferring between systems in the same deployment cluster, or between privately managed and public cloud systems, method 600 may perform replication of data as discussed herein.

In an embodiment, method 600 may allow the reuse of previously deployed Virtual Data Models as discussed herein. In an embodiment, method 600 may utilize private basic views. Private views can encapsulate certain SQL application logic on one or more database tables or even other views. Private views may be devoid of business semantics and may be intended for reuse in other views of a virtual data model. They may be comparable to subroutines or (private) methods in programming languages. A private view may be based on database tables, other private views or on reuse views.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A method comprising:
loading data from one or more source systems to a target system;
tracking changes to the data of each source system;
in response to a change in the data of a source system, replicating data from that source system to the target system;
defining one or more views of the data within the target system;
combining the views of the data within the target system into a cross view to create a virtual data model of the data within the target system; and
performing analytics on the virtual representation of the data.

2. The method of claim 1, wherein the data from each source system is replicated to a respective schema of the target system, and wherein each view is defined based on the data in a respective schema.

3. The method of claim 2, wherein a view for a first schema is defined and views for subsequent schemas are defined using table functions.

4. The method of claim 1, wherein the target system comprises an empty database environment and an empty application server prior to loading data.

5. The method of claim 1, further comprising, performing data harmonization prior to a loading or replicating operation.

6. The method of claim 1, wherein tracking changes in the data of a source system further comprises creating database triggers and change logs to detect and monitor changes in the data of a source system.

7. The method of claim 1, wherein delta logging is used in replicating data.

8. The method of claim 1, wherein data replication occurs in real time.

9. The method of claim 1, wherein data replication occurs at scheduled intervals.

10. The method of claim 1, wherein the target system is an empty database and a corresponding application server able to handle data from a large number of source systems.

11. The method of claim 1, further comprising adding client identification information to views and determining, based on client identification filters which views to combine into cross views, wherein the data being replicated represents data from a plurality of clients.

12. The method of claim 1, wherein the virtual data model can be reused for subsequent analytics.

13. A system comprising:
one or more source systems, each containing one or more application database tables, wherein each source system is configured to track changes to data within its application database tables;
a replication unit, configured to load data from one or more source systems to a target system and in response to a change in the data of a source system, replicate the data from that system to a target system;
a database environment, configured to store replicated data; and
an application server configured to:
define views of the data stored in the database environment,
combine the views into a cross view to create a virtual data model, and
perform data analytics on the cross view.

14. The system of claim 12, wherein the replication unit is further configured to replicate data from each source system to a respective schema of the database environment.

15. The system of claim 13, wherein to define views, the application server is further configured to define a view for each schema within the database environment.

16. The system of claim 12, wherein the database environment and the application server are empty prior to any loading of data.

17. The system of claim 12, wherein the application server is further configured to add client identification information to views and determine, based on client identification filters which views to combine into cross views, wherein the data being replicated represents data from a plurality of clients.

18. The system of claim 12, wherein the replication unit is further configured to replicate data in real time.

19. The system of claim 12, wherein the replication unit is further configured to replicate data at scheduled intervals.
